(19) United States
(12) Patent Application Publication
(10) Pub. No.: US 2005/0083696 A1
(43) Pub. Date: Apr. 21, 2005

(54) Structure of LED illuminating apparatus

(76) Inventors: Po-Liang Chiang, Taipei City (TW); Yi-Wei Liu, Taipei (TW)

Correspondence Address: LOWE HAUPTMAN GILMAN;& BERNER, LLP, Suite 310, 1700 Diagonal Road, Alexandria, VA, 22314, US

(21) Appl. No.: 10/687,618

(22) Filed: Oct. 20, 2003

(51) Int. Cl. F21V 1/00

(52) U.S. Cl. 362/268

(57) ABSTRACT

The present invention provides a structure of an LED illuminating apparatus, which is used as the light source to prevent damage to the optical components by the UV and IR radiation emitted from the conventional UHP mercury lamp. The red, green, and blue monochromatic LED arrays emit desirable wavelengths such as the primary colors rather than starting with a broadband light source and filter out the undesired wavelengths of the conventional projector.

### BACKGROUND OF THE INVENTION

1. Field of the Invention

This invention relates to an illuminating apparatus, more particularly to an LED (light emitting diode) illuminating apparatus that is adapted for use as a light source in a projector.

2. Description of the Prior Art

The projector has been used for many years to project motion pictures and still photographs onto screens for viewing. The projector has recently become a must-have business and teaching tool. Presentations using a multimedia projector are common for conducting sales demonstrations, business meetings, and classroom instruction. And as the projector is lighter, more compact than and less expensive as before, a number of customers even bring a movie theater into their home by using a state-of-the-art projector.

FIG. 1 is a plan showing the structure on the optical engine of a conventional projector 100. The conventional projector 100 is composed of an illuminating system, an optical color separating-recombining system, and an imaging system. The illuminating system is composed of an ultra high-pressure mercury lamp 101 (hereinafter referred to as an “UHP” mercury lamp), a reflector 103, an ultraviolet-infrared cut filter 105 (hereinafter referred to as a “UV-IR” cut filter), an optical integrator 107, and a polarization conversion system 113. The color separating-combining system is composed of reflecting mirrors 115, 117, 119 and 121, condense lens 123, 125, 127, 129R, 129G and 129B, a blue-and-green-reflecting dichroic mirror 131, a green-reflecting dichroic mirror 133, and an X-cube 135. The imaging system is composed of liquid crystal display light valve panels 137R, 137G and 137B (hereinafter referred to as “LCD” light valve panels), a projection lens 139, and a projection screen 141.

The illuminating system is designed to provide a steady optical throughput efficiently passing through the projector 100 and relayed to a precise optical-path design. The illuminating system uses a high-intensity discharge lamp (HID lamp), UPH mercury lamp 101 as the light source, which has an efficient emission of illumination light. The reflector 103 with a parabolic reflection mirror is designed to reflect light emitted from the UHP mercury lamp 101 to become a parallel light beam and let it pass through the UV-IR cut filter 105 to filter out the wavelength region of ultraviolet and infrared. The optical integrator 107 is composed of a first lens array 109 and a second lens array 111 serving as uniform-illumination optical elements. The first lens array 109 has a plurality of rectangular lenses arranged in the form of a matrix, this divides the light beam emitted from the light source into a plurality of partial light beams, and condenses the partial light beams near the second lens array 111. The second lens array 111 has a plurality of rectangular lenses arranged in the form of a matrix, which has the function of superimposing the partial light beams emitted from the first lens array 109 onto the LCD light valve panels 137R, 137G and 137B (described hereinbelow). In order to raise the efficiency of light utilization, the polarization conversion system 113 is used to convert unpolarized light from the light source to one type of linearly polarized light.

The optical color separating-recombining system is used to separate the polarized white light from the illuminating system into red (R), green (G), and blue (B) wavelength regions. Three primary light beams of red, green, and blue are modulated and added with further image information by the corresponding LCD light valve panels 137R, 137G, and 137B. These LCD light valve panels 137R, 137G, and 137B are subjected to switching control according to image information by the driver board (not showed), and the light of respective colors passed is modulated. After passing through the LCD light valve panels 137R, 137G, and 137B, the light beams of red, green, and blue enter the X-cube 135, where they are recombined into a color image and projected via the projection lens 139 onto a projection screen 141 located at a predetermined position.

The blue-and-green-reflecting dichroic mirror 131 and the green-reflecting dichroic mirror 133 are arranged to execute the optical color separation. After being reflected at a right angle by the reflecting mirror 115 and collimated by the condense lens 123, the blue light beam and the green light beam emitted from the illuminating system are reflected at a right angle by the blue-and-green-reflecting dichroic mirror 131, and are directed toward the green-reflecting dichroic mirror 133. The red light beam passes through the blue-and-green-reflecting dichroic mirror 131, and is reflected at a right angle by the rearward reflecting mirror 117, and then collimated to pass through the condense lens 129R. The beams are then emitted toward the LCD light valve panels 137R where they are modulated.

Next, of the blue and green light beams that are reflected by the blue-and-green-reflecting dichroic mirror 131, only the green light beam is reflected at a right angle by the green-reflecting dichroic mirror 133. The green light beam is collimated to pass through the condense lens 129G, and is emitted toward the LCD light valve panels 137G where they are modulated.

The blue light beam passes through the green-reflecting dichroic mirror 133, and is collimated to pass through the condense lens 125, and then is reflected at a right angle by the reflecting mirror 119, and passes through the intermediate condense lens 127, to be reflected at a right angle by the reflecting mirror 121, and then collimated to pass through the condense lens 129B, to be emitted toward the LCD light valve panels 137B where the beam is finally modulated. With regard to the blue optical path, which is longer than the other two paths, the condense lens 125, the reflecting mirror 119, the condense lens 127, the reflecting mirror 121 and the condense lens 129B are arranged to be an optical relay system to make the illumination distribution the same as the other colors.

Three above-mentioned primary light beams of red, green, and blue are modulated and added with further image information by the corresponding LCD light valve panels 137R, 137G, and 137B. The X-cube 135 is a cubical prism, used for recombining the modulated red, green and blue light beams into a color image and diminishing the deterioration of resolution caused in the process of color recombination. The color image, integrated by the X-cube 135, is not only projected but also enlarged via the projection lens 139 onto the projection screen 141. Furthermore, the projection lens 139 is arranged to eliminate the chromatism of the color image.

The conventional projector 100 uses the UPH mercury lamp 101 as the light source. The UPH mercury lamp 100 is a high-intensity discharge lamp, using an arc and pure mercury vapor under high pressure to create greater lighting efficiency. In the meantime, the UV radiation-sensitive optical components in the projector absorb some of the intense UV and IR radiation emitted from the UHP mercury lamp 100. However other optical components, including the UHP mercury lamp 101 itself will be heated by the IR radiation and result in a shorter service life. The conventional projector 100 utilizes the UPH mercury lamp 101 as the light source, which over loads the cooling-system (not showed) of the projector 100, and furthermore, forces a restriction on the use of materials around the optical components and heightens the fabrication cost of the projector 100.

The conventional projector 100 uses the UPH mercury lamp 101 as the light source. The UHP mercury lamp 101 provides a high luminous efficiency in the visible region. A sufficient light intensity can be ensured in the blue and green wavelength regions. However, the light intensity is insufficient in the red wavelength region. In order to balance the light intensity, in the projector 100, the light intensity of the blue and green wavelength regions is reduced and adjusted to the level of the red wavelength region. Part of the illumination light emitted from the UHP mercury lamp is wasted, and this makes the displayed image darker. Hence, utilizing the UPH mercury lamp 101 as the light source will complicate the structure of the optical color separating-recombining system in the conventional projector 100.

The conventional projector 100 uses the UPH mercury lamp 101 as the illuminating system light source. The reflecting mirrors 115, 117, 119 and 121, the condense lens 123, 125, and 127, the blue-and-green-reflecting dichroic mirror 131, and the green-reflecting dichroic mirror 133 are arranged to separate the polarized white light from the illuminating system into red, green, and blue light beams. Then the three primary light beams of red, green, and blue are modulated and added with further image information by the corresponding LCD light valve panels 137R, 137G, and 137B. As above described, the relative positions and the arrangement of the optical separation components are very complicated, and any unexpected knock might lead to displacement or damage.

### SUMMARY OF THE INVENTION

The present invention has been made in view of the above problems, and an object of the invention is to provide an LED illuminating apparatus, which is used as the light source to prevent optical components from being harmed by the UV and IR radiation emitted from an UHP mercury lamp in a conventional projector.

Another object of the present invention is to provide an LED illuminating apparatus as the light source to take the place of the UHP mercury lamp in a conventional projector. With a longer service life as the light source, the LED illuminating apparatus won't need to be replaced as frequent.

The other object of the present invention is to provide an LED illuminating apparatus as the light source of a projector. Lights are emitted directly from monochromatic red, green, and blue LED arrays, integrated by an X-Cube, and finally an image is formed via a projector lens. This invention will omit the optical components, which are arranged to separate the light emitted from the UHP Mercury lamp into monochromatic red, green, and blue light beams in the conventional projector.

According to the above-described objects of the present invention, an LED illuminating apparatus, which is used as the light source to prevent optical components from being harmed by the UV and IR radiation emitted from an UHP mercury lamp in a conventional projector. According to the present invention, lights are emitted directly from monochromatic red, green, and blue LED arrays, integrated by an X-Cube, and finally an image is formed via a projector lens. This invention will omit the optical components, which are arranged to separate the light emitted from the UHP Mercury lamp into monochromatic red, green, and blue light beams in the conventional projector.

These and other objects, features, and advantages of the present invention will become apparent to those skilled in the art upon a reading of the following detailed description when taken in conjunction with the drawings wherein it's shown and described as an illustrative embodiment of the invention.

### BRIEF DESCRIPTION OF THE DRAWINGS

The invention will be described further, by way of example, with reference to the accompanying drawings, in which:

FIG. 1 is a plan showing the structure on the optical engine of a conventional projector 100;

FIG. 2 is a plan showing a preferred embodiment of an LED illuminating apparatus in according with the present invention;

FIG. 3 is a plan showing another preferred embodiment of a LCD projector in according with of the present invention;

FIG. 4 is a plan showing the other preferred embodiment of a LCOS projector in according with of the present invention.

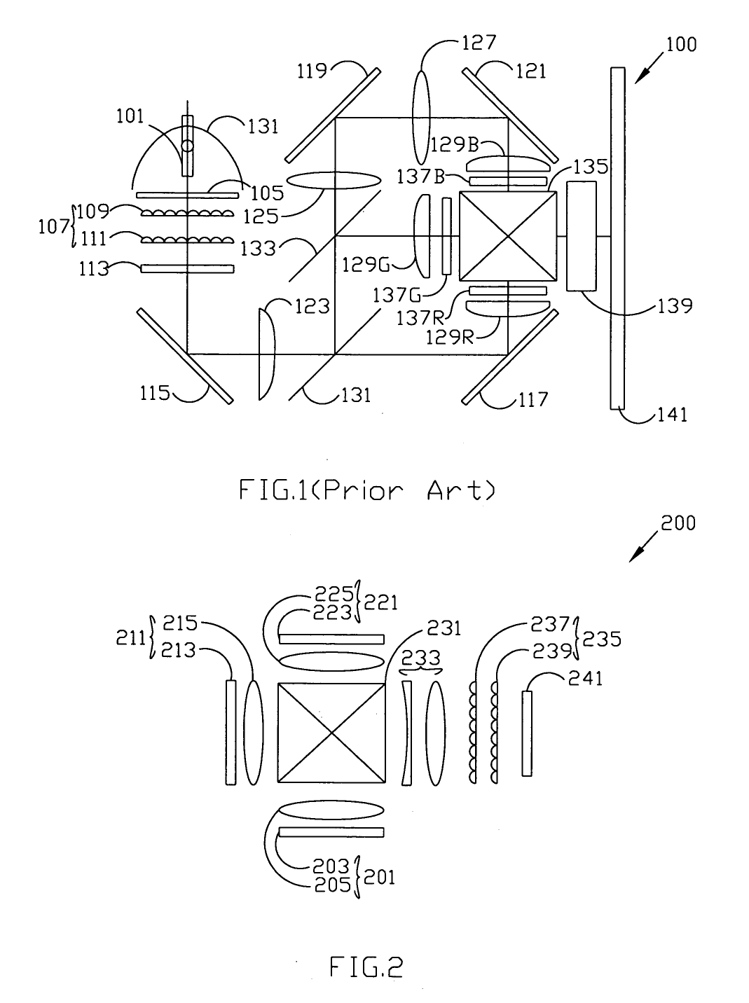

### DESCRIPTION OF THE PREFERRED EMBODIMENT

FIG. 2 is a plan showing a preferred embodiment of an LED illuminating apparatus 200 in accordance with the present invention. The LED illuminating apparatus 200 is composed of a red LED module 201, a green LED module 211, a blue LED module 221, an X-cube 231, a lens module 233, an optical integrator 235, and a polarization conversion system 241.

The red LED module 201 is composed of a red monochromatic LED array 203 and a corresponding condense lens 205. The green LED module 211 is composed of a green monochromatic LED array 213 and a corresponding condense lens 215. The blue LED module 221 is composed of a blue monochromatic LED array 223 and a corresponding condense lens 225. Three plane lights, emitted from the red, green, and blue monochromatic LED arrays 203, 213, and 223 sequentially or simultaneously, provide a steady optical throughput which passes through the corresponding condense lens 205, 215 and 225, and is collimated toward the X-cube 231. The X-cube 231 is a cubical prism, used for integrating the red, green and blue monochromatic lights toward the lens module 233.

The optical integrator 235 is composed of a first lens array 237 and a second lens array 239 serving as uniform-illumination optical elements. The first lens array 237 has a plurality of rectangular lenses arranged in the form of a matrix. This divides lights transmitted from the lens module 233 into a plurality of partial light beams, and condenses the partial light beams near the second lens array 239. The second lens array 239 has a plurality of rectangular lenses arranged in the form of a matrix, and has the function of superimposing the partial light beams emitted from the first lens array 237 onto the PCB system 241. In order to raise the light utilization efficiency, the polarization conversion system 241 is used to convert unpolarized light beams to one type of linear polarized light beams.

According to the above-described preferred embodiment of the present invention, the LED illuminating apparatus 200 utilizes the red, green, and blue monochromatic LED arrays 203, 213, and 223 as the light source to prevent optical components from being exposed to the UV and IR radiation emitted from an UHP mercury lamp of a conventional projector. The red, green, and blue monochromatic LED arrays 203, 213, and 223 emit desirable wavelengths such as the primary colors rather than starting with a broadband light source which filters out the undesired wavelengths. In addition, the red, green, and blue monochromatic LED arrays 203, 213, and 223 offer a longer service life, better primary colors, electronic sequencing of the colors for better color depth, and dynamic adjustment of the color temperature by directly controlling the amount of red, green, and blue light generated.

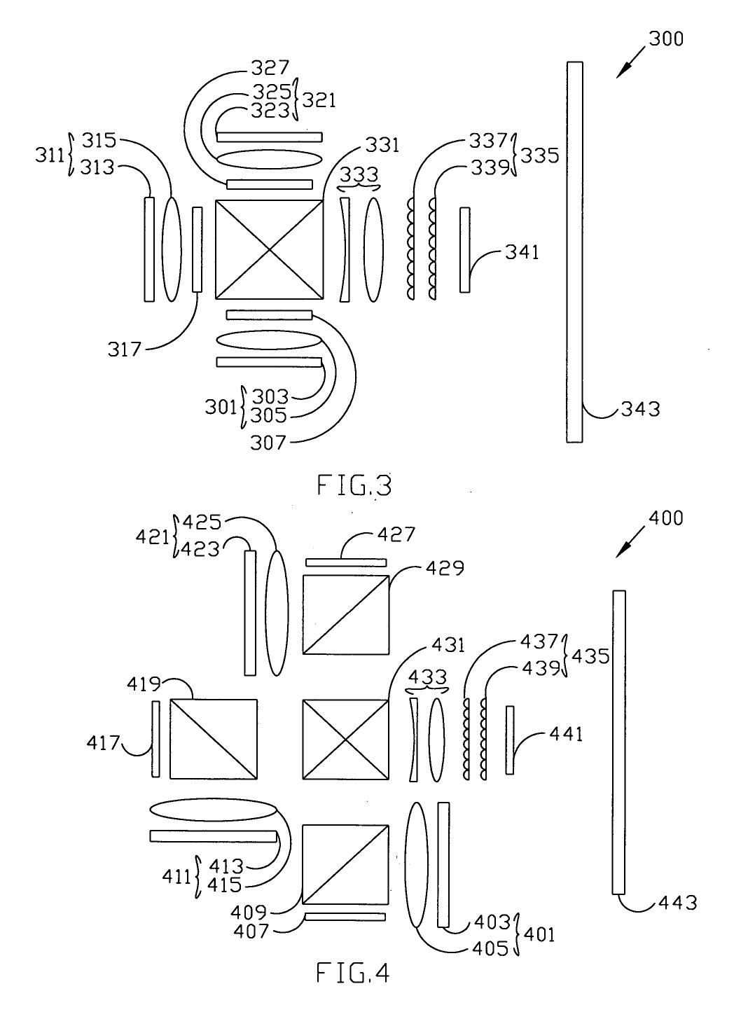

FIG. 3 is a plan view showing another preferred embodiment of a LCD projector 300 in according with of the present invention. The LCD projector 300 is composed of a red LED module 301, a green LED module 311, a blue LED module 321, three LCD light valve panels 307, 317, and 327, an X-cube 331, a lens module 333, a optical integrator 335, a polarization conversion system 341, and a projection screen 343.

The red LED module 301 is composed of a red monochromatic LED array 303 and a corresponding condense lens 305. The green LED module 311 is composed of a green monochromatic LED array 313 and a corresponding condense lens 315. The blue LED module 321 is composed of a blue monochromatic LED array 323 and a corresponding condense lens 325. Three plane lights, emitted from the red, green, and blue monochromatic LED arrays 303, 313, and 323 sequentially or simultaneously, provide a steady optical throughput which passes through the corresponding condense lens 305, 315 and 325, which are then collimated toward the LCD light valve panels 307, 317, and 327. The LCD light valve panels 307, 317, and 327 are subjected to switching control according to image information by the driver board (not showed), and the light of respective colors passed are modulated. After passing through the LCD light valve panels 307, 317, and 327, three gray-scale images of red, green, and blue enter the X-cube 331. The X-cube 331 is a cubical prism, used for integrating the red, green and blue gray-scale images toward the lens module 333.

The optical integrator 335 is composed of a first lens array 337 and a second lens array 339 serving as uniform-illumination optical elements. The first lens array 337 has plurality of rectangular lenses arranged in the form of a matrix, divides image transmitted from the lens module 333 into a plurality of partial images, which then condenses the partial images near the second lens array 339. The second lens array 339 has a plurality of rectangular lenses arranged in the form of a matrix, which has the function of superimposing the partial images emitted from the first lens array 337 onto the polarization conversion system 341. In order to raise the efficiency of light utilization, the polarization conversion system 341 is used to convert the light beams to a specific type of linear polarized light beam. Finally, a color image is projected to a projection screen 343 located at a predetermined position.

FIG. 4 is a plan showing another preferred embodiment of a LCOS projector 400 in accordance with of the present invention. The LCOS (Liquid Crystal On Silicon) projector 400 is composed of a red LED module 401, a green LED module 411, a blue LED module 421, three LCOS light valve panels 407, 417, and 427, the corresponding polarizing beam splitters 409,419, and 429, an X-cube 431, a lens module 433, a optical integrator 435, a polarization conversion system 441, and a projection screen 443.

The red LED module 401 is composed of a red monochromatic LED array 403 and a corresponding condense lens 405. The green LED module 411 is composed of a green monochromatic LED array 413 and a corresponding condense lens 415. The blue LED module 421 is composed of a blue monochromatic LED array 423 and a corresponding condense lens 425. Three plane lights, emitted from the red, green, and blue monochromatic LED arrays 403, 413, and 423 sequentially or simultaneously, provide a steady optical throughput which passes through the corresponding condense lens 405, 415 and 425, which is collimated toward the LCOS light valve panels 407, 417, and 427. The LCOS light valve panels 407, 417, and 427, referred to as “reflective LCD”, is subjected to a switching control according to the image information by the driver board (not showed), then the respective color of incident lights are modulated. The corresponding polarizing beam splitters 409,419, and 429 are arranged to direct the unmodulated lights from the red, green, and blue monochromatic LED arrays 403, 413, and 423 to enter the respective LCOS light valve panels 407, 417, and 427, and guide the reflective modulated gray-scale images toward the X-cube 431. The X-cube 431 is a cubical prism, it's used for integrating the red, green and blue gray-scale images toward the lens module 433.

The optical integrator 435 is composed of a first lens array 437 and a second lens array 439 serving as uniform-illumination optical elements. The first lens array 437 has a plurality of rectangular lenses arranged in the form of a matrix, which divides the transmitted image from the lens module 433 into a plurality of partial images, and then condenses the partial images near the second lens array 439. The second lens array 439 has a plurality of rectangular lenses arranged in the form of a matrix, which has the function of superimposing the partial images emitted from the first lens array 437 onto the polarization conversion system 441. In order to raise the efficiency of the light utilization, the polarization conversion system 441 is used to convert unpolarized light beams in to a type of linear polarized light beams. Finally, a color image is projected to a projection screen 443 located at a predetermined position.

According to above-described preferred embodiments of the present invention, optical components in the projectors that utilize an LED illuminating apparatus as the light source are not exposed to UV and IR radiation emitted from the conventional UHP mercury lamp. The red, green, and blue monochromatic LED arrays emit desirable wavelengths such as the primary colors rather than starting with a broadband light source which has to filter out the undesired wavelengths as in the conventional projector.

Skilled workers will further recognize that many changes may be made to the details of the above-described embodiment of this invention without departing from the underlying principles thereof. Accordingly, it will be appreciated that this invention is also applicable to color synchronization applications other than those found in multimedia projectors. The scope of the present invention should, therefore, be determined only by the following claims.

1. A structure of LED illuminating apparatus, comprising:
a plurality of LED modules; and
a cubical prism surrounded by said plurality of LED modules, arranged to integrate lights emitted from said plurality of LED modules.

2. The structure of LED illuminating apparatus according to claim 1, wherein said plurality of LED modules comprise a red LED module, a green LED module, and a blue LED module.

3. The structure of LED illuminating apparatus according to claim 2, wherein said red LED module comprises a red LED array and a corresponding condense lens, said condense lens is arranged between said red LED array and said cubical prism.

4. The structure of LED illuminating apparatus according to claim 2, wherein said green LED module comprises a green LED array and a corresponding condense lens, said condense lens is arranged between said green LED array and said cubical prism.

5. The structure of LED illuminating apparatus according to claim 2, wherein said blued LED module comprises a blue LED array and a corresponding condense lens, said condense lens is arranged between said blue LED array and said cubical prism.

6. The structure of LED illuminating apparatus according to claim 1 further comprising a lens module, arranged on a light outgoing side of said cubical prism.

7. The structure of LED illuminating apparatus according to claim 6 further comprising an optical integrator, arranged on a light outgoing side of said lens module.

8. The structure of LED illuminating apparatus according to claim 7, wherein said optical integrator comprise a first lens array and a second lens array.

9. The structure of LED illuminating apparatus according to claim 7 further comprising a polarization conversion system on a light outgoing side of said optical integrator.

10. A structure of projector with an LED illuminating apparatus, comprising:
a plurality of LED modules as a light source;
a plurality of LCD light valve panels, arranged to modulate lights emitted from said corresponding LED modules;
a cubical prism surrounded by said plurality of LCD light valve panels, arranged to integrate modulated lights transmitted from said plurality of LCD light valve panels; and
a lens module, arranged on a light outgoing side of said cubical prism.

11. The structure of projector with an LED illuminating apparatus according to claim 10, wherein said plurality of LED modules comprise a red LED module, a green LED module, and a blue LED module.

12. The structure of projector with an LED illuminating apparatus according to claim 11, wherein said red LED module comprises a red LED array and a corresponding condense lens, said condense lens is arranged between said red LED array and said corresponding LCD light valve panel.

13. The structure of projector with an LED illuminating apparatus according to claim 11, wherein said green LED module comprises a green LED array and a corresponding condense lens, said condense lens is arranged between said green LED array and said corresponding LCD light valve panel.

14. The structure of projector with an LED illuminating apparatus according to claim 11, wherein said blue LED module comprises a blue LED array and a corresponding condense lens, said condense lens is arranged between said blue LED array and said corresponding LCD light valve panel.

15. The structure of projector with an LED illuminating apparatus according to claim 10 further comprising an optical integrator, arranged on a light outgoing side of said lens module.

16. The structure of projector with an LED illuminating apparatus according to claim 15, wherein said optical integrator comprises a first lens array and a second lens array.

17. The structure of projector with an LED illuminating apparatus according to claim 15 further comprising a polarization conversion system on a light outgoing side of said optical integrator, arranged to raise the light utilization efficiency and project a color image to a projection screen.

18. A structure of projector with an LED illuminating apparatus, comprising:
a plurality of LED modules as a light source;
a plurality of LCOS light valve panels, arranged to modulate lights emitted from said corresponding LED modules;
a plurality of polarizing beam splitters, arranged to direct unmodulated lights emitted from said corresponding LED modules enter said corresponding of LCOS light valve panels;
a cubical prism surrounded by said plurality of polarizing beam splitters, arranged to integrate the modulated lights transmitted from said plurality of polarizing beam splitters; and
a lens module, arranged on a light outgoing side of said cubical prism.

19. The structure of projector with an LED illuminating apparatus according to claim 18, wherein said plurality of LED modules comprise a red LED module, a green LED module, and a blue LED module.

20. The structure of projector with an LED illuminating apparatus according to claim 19, wherein said red LED module comprises a red LED array and a corresponding condense lens, said condense lens is arranged between said red LED array and said corresponding polarizing beam splitter.

21. The structure of projector with an LED illuminating apparatus according to claim 19, wherein said green LED module comprises a green LED array and a corresponding condense lens, said condense lens is arranged between said green LED array and said corresponding polarizing beam splitter.

22. The structure of projector with an LED illuminating apparatus according to claim 19, wherein said blue LED module comprises a blue LED array and a corresponding condense lens, said condense lens is arranged between said blue LED array and said corresponding polarizing beam splitter.

23. The structure of projector with an LED illuminating apparatus according to claim 18 further comprising an optical integrator, arranged on a light outgoing side of said lens module.

24. The structure of projector with an LED illuminating apparatus according to claim 23, wherein said optical integrator comprises a first lens array and a second lens array.

25. The structure of projector with an LED illuminating apparatus s according to claim 23 further comprising a polarization conversion system on a light outgoing side of said optical integrator, arranged to raise the light utilization efficiency and project a color image to a projection screen.
